(19) United States
(12) Patent Application Publication
(10) Pub. No.: US 2007/0071212 A1
(43) Pub. Date: Mar. 29, 2007

(54) Method to block switching to unsolicited phone calls

(75) Inventors: Juergen Quittek, Heidelberg (DE); Saverio Niccolini, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/471,587

(22) Filed: Jun. 21, 2006

(30) Foreign Application Priority Data
Jun. 22, 2005 (DE) 102005029 287.9

(51) Int. Cl. H04M 3/42

(52) U.S. Cl. 379/210.02

(57) ABSTRACT

A method to control switching of telephone calls of at least one caller with at least one more callee using a filter is—regarding a filtering that is as efficient as possible with a minimum impact on the regular phone operation—designed in such a way that before switching the telephone call to the callee, a test is performed by the filter to identify the telephone calling behavior of the caller.

### BACKGROUND OF THE INVENTION

1. Field of the Invention

The invention relates to a method to block switching of unsolicited phone calls.

2. Description of the Related Art

In the area of electronic mail unsolicited bulk email messages—so-called SPAM—have become very common and have turned into a severe problem. Not only companies that require email communication are impacted by SPAM messages, but also private users are very annoyed by SPAM. Many Internet users nowadays receive more SPAM messages than regular emails. For this reason, almost every server for incoming email uses SPAM filters which check incoming mails according to defined rules. They search, for example, actively for key words in the content of an email, they check specific configurations of the server used for sending the email or they search for senders that are often used for sending bulk emails. In case of a matching classification of an email as SPAM, it is marked and/or sorted out.

In the area of—analog or digital—telephony, SPAM also occurs more and more often, as it can be seen, for example, in case of unsolicited commercial calls. These calls are mostly made by automated calling machines. Due to the currently and mainly employed switched telephone networks, such SPAM calls are very complicated and expensive which is the reason for a rather restricted number of SPAM calls. When Internet telephony will be used more commonly, such SPAM calls will become much easier and cheaper, so a tremendous increase of SPAM calls will have to be assumed. For this reason, a corresponding filtering of calls according to certain rules will become necessary.

The methods applied with email SPAM filters can not or only partly be transferred to telephony. For example, a SPAM filter searches the whole content of an email before transmitting the message to the addressee (See J. Carpinter et al., “Tightening the net: a review of current and next generation spam filtering tools”, in proceedings of Asia Pacific Regional Internet Conference on Operational Technologies 2006 (APRICOT 2006), Perth, Australia, February 2006; and William S. Yerazunis, “The Spam-Filtering Accuracy Plateau at 99.9% Accuracy and How to Get Past It”, in proceedings of 2004 MIT Spam Conference, Cambridge, Mass., U.S.A., March 2004). Such a procedure is not possible in case of phone calls, because the content of a phone call will become known only during the conversation.

### SUMMARY OF THE INVENTION

Hence, the present invention is based on the task to design and further develop a method of the above mentioned kind that unsolicited SPAM calls can be efficiently blocked, whereby the regular phone operation shall be impacted the least possible and the call participants shall be annoyed the least possible.

The task mentioned above is solved by a method showing the characteristics of patent claim 1. According to this, for the proposed method to block switching of unsolicited phone calls of at least one caller (1) with at least one callee (2), a filter (3) is provided, wherein a test is performed before switching the call to the callee (2) by a filter (3) in order to identify the calling behavior of the caller (1).

According to the invention, it has first been recognized that unsolicited phone calls, in particular those made by calling machines, can be blocked very efficiently by easy means, also without knowing further details about the content of the phone call. For this purpose, it is checked before switching the phone call to the callee by means of a test whether the caller shows a behavior common in phone calls.

Phone calls in general start by following a specific behavior pattern. After a callee has accepted a phone call, he/she normally starts with a salutation, his/her name, the company name and/or other formal conventions. After that, a question may follow, for example asking for the reason of the call. Subsequently, the caller answers, reacts to the salutation and may then answer the question if applicable. As soon as the caller has finished, the callee reacts to the statements of the caller. Typically, only after that the actual phone call starts.

According to the invention, it has been recognized that in case of calls made by calling machines this behavior pattern is not respected. In most cases, calling machines start with their advertising message immediately after successful connection and do not respect the common phone call behavior. In particular, there is no reaction to a salutation and/or questions are not answered. For this reason, parts of the speech of the caller and the callee will overlap inevitably.

According to the invention, this pattern of behavior is hence used to check whether the call is made by a human being or a calling machine. For this purpose, a filter is employed that receives the calls coming in at a callee's and checks the phone call behavior of the caller with a test. The filter simulates the start of a call of a “regular” phone call and observes the reactions of the caller. For this purpose, preferably pre-recorded voice messages with a salutation, the company name or the like are played. Only after passing the test, the phone call is switched to the callee. By these means, the establishment of unsolicited phone calls, in particular those of calling machines, can be blocked very efficiently.

In an especially advantageous manner the method according to the invention can be used in digital networks as well as in analog telephone networks. It does not matter whether it is a connection-oriented telephone network—for example, an analog telephone—or a connectionless network—such as the IP telephony. The method according to the invention is hence universally applicable and is not restricted to any specific technology.

In a preferred embodiment of the invention, the test comprises a Turing test which can be used to determine the intelligent phone call behavior of the caller. Turing tests originally stem from the beginning era of the special field of informatics of artificial intelligence and were originally used to judge the behavior of a machine in interaction with a human being. A real person follows the conversation of two parties having a so-called “chat”—a “discussion”—without seeing or hearing them (i.e. their “chat” is shown to the real person under the form of text). If the real person is not able to clearly identify if one of the parties of the conversation is a machine, the machine to be tested has passed the Turing test.

Transferred to a SPAM filter for telephony, the Turing test represents the checking of behavior in a conversation according to some conventional rules. For this reason, the conversation pattern of the caller is checked with the test at the beginning of the conversation and then compared to an expected conversation pattern.

For this purpose, arbitrarily complex test patterns with a basically arbitrary number of interactions can be used. In case of several interactions the probability increases very much that an unsolicited phone call of a calling machine is detected. Nevertheless, the test must not exceed a certain duration and complexity which is acceptable for the call participants in order to achieve a possibly high acceptance.

In another preferred design of the invention, the energy or another characteristic of the audio signal, which allows detecting whether the caller is talking or silent, in the communication channel is employed to determine the conversation pattern. For this purpose, first of all the background noise at the caller's side is determined by an automatic threshold re-adjustment and a threshold of the characteristic is then adjusted in such a way that the detected signal is below this threshold. If parts of the signal show a higher energy or a higher value of another characteristic of the audio signal than the threshold, they are interpreted as parts of the speech of the call participant. The threshold can be continuously adjusted during the whole test, but it has to be taken care that no changes are made while the caller is speaking. Due to the analysis of the signal energy or another characteristic of the audio signal, an especially cost-effective detection circuit can be realized. The characteristic of the audio signal can be chosen in such a way that it can be extracted with the least effort at the currently used audio coding.

By a more detailed analysis of the audio signal, non-constant sources of disturbance can be detected in addition. In this sense, for example, with a frequency analysis irregularly occurring sounds of wind or cars passing by the caller can be identified, because they usually show a characteristic spectrum. The information gained by that can in turn be used for adjusting the threshold. For this reason, the method according to the invention can also be used if the caller is located in an environment with very much varying background noises.

Regarding the least annoying performance of the test, the voice signal and the speech sequences identified from there, can be used to control the playing of recorded voice messages. When determining the speech parts of the caller, the start of playing a voice message should be omitted. Only the salutation directly after accepting the call must not be blocked by speech parts of the caller. By doing so, it can efficiently be secured that no overlapping between the speech parts of the caller and the played voice message of the filter occur. In addition, it can be achieved that there no long breaks between the statements of the caller and the reactions of the filter will occur.

In a further design of the invention, the conversation is followed by speech recognition. In this case, the statements of the caller can better be responded and reacted to. In case of a multi-stage test, i.e. a test with several interactions, the test can be adjusted according to the answers of the caller. In particular, a further and very efficient measure can be realized with which the knowledge of the caller is checked. It is possible to search for specific words in the statements of the caller regarding a question that was played by the filter. For example, if there is a question that is supposed to be answered by saying the name of the person to talk to, the speech recognition can search for specific names and only after getting a known name within a pre-determined time proceed with the test or switch the call to the callee. In case of an advertising call of a calling machine or of a person, such information is in general not available.

If the test is not passed by the caller, the call will preferably not be switched to the callee and the call will automatically be finished. The fact that the test wasn't passed can be recorded and/or the callee be informed in an appropriate manner. The phone identifier of the caller can, for example, be added to a list and the callee can be indicated a new entry in the list. But if the test is passed, the call is switched to the callee and a corresponding signaling of the call is initiated.

Hence, the callee is only indicated actively the incoming phone call if the caller passed the test and it is therefore probable that the switched phone call is no SPAM.

In addition, the filter can be provided white lists and/or black lists and/or gray lists. By these means, it is especially easy to achieve that callers are the least possible impacted or annoyed by the tests. In case of white lists, all the phone identifiers are listed that are switched to the callee without performing the test. The callee can enter known and solicited callers into the list. Additionally, after having passed the test, the filter can add the phone identifier to the white list, so a caller will have to pass the test only once. In contrast, black lists contain phone identifiers of callers who have not passed the test once or several times. Corresponding calls with this phone identifier are automatically rejected without performing a test. In addition, the caller can be offered the chance to add phone identifiers intentionally to a black list. With gray lists all those phone identifiers can be stored that phoned once or more times without passing the test. In case of callers with a phone identifier from a gray list, once again a test is performed. If the caller again does not pass the test repeatedly, the phone identifier is moved to the black list after a pre-determinable number of trials. By keeping these lists it can be prevented that callers have to do and to pass tests repeatedly. By these means, callers are the least affected by the performance of tests.

Regarding an especially universal application of the method according to the invention, the filter can be implemented for securing a single phone or for securing a whole telephone system. When applying the filter to a single phone, the filter can directly be integrated in the phone.

Now, there are several options of how to design and to further develop the teaching of the present invention in an advantageous way. For this purpose, it must be referred to the claims subordinate to claim 1 on the one hand and to the following explanation of a preferred example of an embodiment of the invention together with the figure on the other hand. In connection with the explanation of the preferred example of an embodiment of the invention and the figure, generally preferred designs and further developments of the teaching will also be explained.

### BRIEF DESCRIPTION OF THE DRAWINGS

FIG. 1 is a block diagram showing an implementation of a method according to the invention, depicted in a schematic model; and

FIG. 2 is a block diagram showing the time flow in case of a test performed as according to the invention, depicted in a schematic model.

### DESCRIPTION OF THE PREFERRED EMBODIMENTS

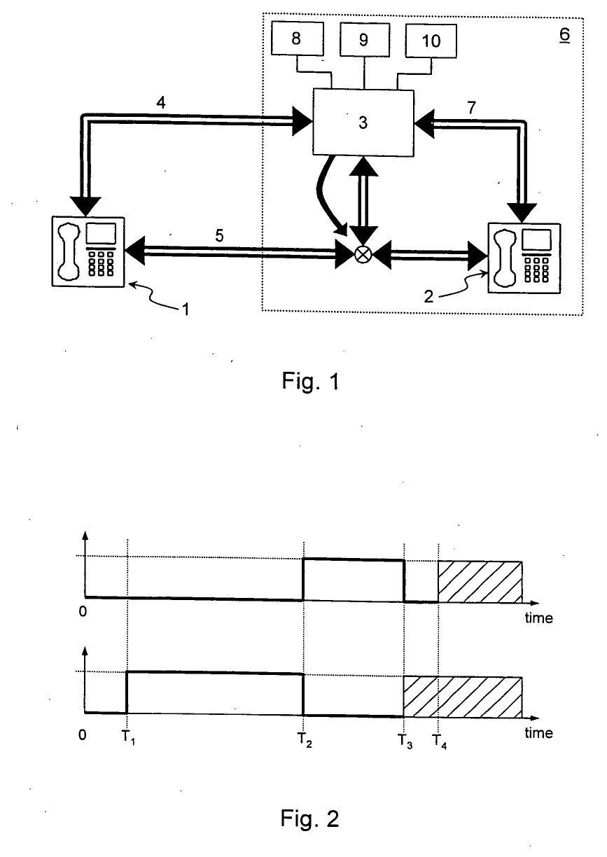

FIG. 1 shows in a schematic model an implementation of the method according to the invention for Internet telephony. A caller 1 tries to call another call participant 2. Both participants are connected to each other over a data network. Before switching the telephone call to the callee 2, a test is performed by filter 3 to find out whether the call is performed by a calling machine. The SPIT filter (SPam over Internet Telephony) first receives a call establishment request 4 from the caller 1. In the following, the phone identifier transmitted along with the call establishment request, is compared to the entries of the white list 8, the black list 9 and the gray list 10. If the identifier is already contained in the white list 8, then the call is directly switched to the callee 2. If the identifier is already contained in the black list 9, then the call is rejected without any further reaction. If the identifier is listed in the gray list 10 or is not found in any of the lists (8, 9, 10), then, according to the invention, the SPIT filter 3 performs a test. For this purpose, the SPIT filter 3 accepts the call and by doing so, acts the function of the callee 2 and sends a voice message recorded at an earlier stage to the caller 1. This message can, for example, say: “Welcome to the company XY”. After that, a question is asked which can be answered shortly by the caller.

For example, the name of the person to whom the caller wants to talk, can be asked for.

During the transmission of the voice message, it is continuously checked whether the energy or another characteristic of audio signal 5 of the caller 1 exceeds an appropriately chosen threshold. If it is detected that the threshold is exceeded, it can be assumed that the call is performed by a calling machine and can hence be rejected as SPIT. But, if the threshold of the caller 1 is exceeded significantly after the question asked by the SPIT filter, and if the duration of the answer of the caller does not exceed a certain maximum duration, the test is interpreted as passed and the call is switched to the protected network 6. Only now the SPIT filter 3 sends an internal call signaling 7 to the callee 2, which generates only then a signal beep or another signaling at the callee's. Simultaneously, the SPIT filter switches all the subsequently arriving voice data 5 to the callee 2. The identifier of the caller 1 is adopted by the SPIT filter 3 in a white list 8.

If the test is not passed, the phone call is rejected and not switched to the callee 2. In addition, the phone identifier of the caller is compared to the entries of a gray list 10. If the identifier is already contained in the list and the maximum number of failed tests is reached due to the current test, the entry is erased from the gray list 10 and added to the black list 9. In any other case, the phone identifier is added to the gray list 10 or the value in a store containing the number of failed tests is increased by one.

FIG. 2 clarifies once more the time flow of the performance of the tests to determine the telephone calling behavior of the caller as according to the invention. In the upper and lower part of the figure, a very simplified depiction of the signal energy or any other characteristic of the audio signal, which allows determining whether the caller is currently talking or remains silent, is shown over the time.

In the upper part of the figure, the change of the of the signal of the caller 1 is shown over time, in the lower part the change of the signal of the callee 2 or, respectively, the one of the SPIT filter 3, which acts in the beginning the function of the callee 2, is shown over time. At time 0 the SPIT filter 3 receives a calling signal and accepts the call at time T1. Until time T2, the SPIT filter 3 plays the previously recorded voice message and waits then for the answer of the caller 1. This is sent by the caller 1 until time T3, which can be recognized by the increase of the signal energy or the other characteristic in the time interval from T2 to T3. After that, it is expected that the caller 1 waits for a certain time until time T4 for a further reaction of the callee 2. In the following, the caller can be indicated that then the call is switched to the intended callee 2. After that, the further flow of the signal energy or of the other characteristic is irrelevant for the SPIT filter 3.

Finally, it is particularly important to point out that the example of an embodiment as chosen arbitrarily above only serves as illustration of the teaching according to the invention, but that it does by no means restrict the latter to the given example of an embodiment.

1. A method to block switching of unsolicited phone calls of at least one caller with at least one callee using a filter, wherein a test is performed by the filter before switching the call to the callee in order to identify the telephone calling behavior of the caller, wherein the conversation pattern of the caller is checked by the test at the beginning of the call and is compared to an expected conversation pattern.

2. The method according to claim 1, wherein the method is applied in order to block calls from calling machines.

3. The method according to claim 1, wherein the test comprises a Turing test to recognize an intelligent telephone calling behavior.

4. The method according to claim 1, wherein the filter analyses the signal energy or another characteristic of the audio signal in the communication channel for monitoring the conversation activity.

5. The method according to claim 4, wherein the level of background noise in the communication channel is determined before analyzing the signal energy or another characteristic of the audio channel.

6. The method according to claim 1, wherein the filter performs speech recognition and/or actively searches for specific words in the statements of the caller.

7. The method according to claim 1, wherein in case the test is not passed, the call is not switched.

8. The method according to claim 1, wherein a failed test is recorded and/or the callee is informed.

9. The method according to claim 1, wherein only after a passed test the call is signaled to the callee.

10. The method according to claim 1, wherein the filter is additionally provided with white lists and/or black lists and/or gray lists and that the lists are additionally or alternatively used to select the calls.

11. The method according to claim 1, wherein the identifier of a caller enters a white list after having passed the test.

12. The method according to claim 1, wherein the identifier of the caller after a failed test enters a black list or a gray list.

13. The method according to claim 1, wherein the method is used for phone calls over a digital network.

14. The method according to claim 1, wherein the method is used for phone calls over an analogue telephone network.
